(19) United States
(12) Patent Application Publication
(10) Pub. No.: US 2003/0067512 A1
(43) Pub. Date: Apr. 10, 2003

(54) Ink jet head, method of manufacturing the same and ink jet recording apparatus

(76) Inventors: Kazutoshi Tominaga, Chiba-shi (JP); Naotoshi Shino, Chiba-shi (JP)

Correspondence Address: ADAMS & WILKS, 31st Floor, 50 Broadway, New York, NY, 10004, US

(21) Appl. No.: 10/245,417

(22) Filed: Sep. 17, 2002

(30) Foreign Application Priority Data
Oct. 10, 2001 (JP) 2001-312235
Mar. 29, 2002 (JP) 2002-096828

(51) Int. Cl. B41J 2/045

(52) U.S. Cl. 347/69

(57) ABSTRACT

To provide an ink jet head in which a solvent-based ink can be used and the amount of deformation in a piezoelectric ceramic plate is limited to ensure improved yield, and a method of manufacturing the ink jet head. In an ink jet head 10 having a piezoelectric ceramic plate 21 in which a plurality of grooves 22 to be filled with a solvent-based ink are formed, and in which electrodes 24 are formed on side walls 23 of the grooves 22, an ink chamber plate 25 joined to the piezoelectric ceramic plate 21 and having a common ink chamber 26 communicating with each of the grooves 22, a nozzle plate 28 joined to an end surface of a joined body 100 formed of the piezoelectric ceramic plate 21 and the ink chamber plate 25, in which end surface the grooves 22 form openings, the nozzle plate 28 having nozzle openings 29 through each of which the solvent-based ink filling the corresponding groove 22 is ejected, and a nozzle support plate 31 provided around a peripheral portion of the joined body 100 on the nozzle plate 28 side, a spacer 110 formed from a material having approximately the same linear expansion coefficient as that of the material of the piezoelectric ceramic plate 21 is provided at least between the surfaces of the piezoelectric ceramic plate 21 and the nozzle support plate 31 of the joined body 100 to be joined to each other.

### BACKGROUND OF THE INVENTION

1. Field of the Invention

The present invention relates to an ink jet head used in a printer or in a facsimile machine for example, and to a method of manufacturing the ink jet head.

2. Description of the Related Art

Ink jet recording apparatuses are known which record characters and images on a recording medium by using an ink jet head having a plurality of nozzles through which ink is jetted. In such ink jet recording apparatuses, an ink jet head is held in a holder so that its nozzles face a recording medium, and the holder is mounted on a carriage which is moved for scanning in direction perpendicular to the direction of conveyance of the recording medium.

FIG. 15 is a schematic exploded perspective view of an example of a head chip of such an ink jet head, and FIG. 16 are cross-sectional views of an essential portion of the ink jet head.

As shown in FIGS. 15 and 16, a plurality of grooves 162 are formed in parallel in a piezoelectric ceramic plate 161 in a state of being separated from each other by side walls 163. One longitudinal end of each groove 162 extends to one end surface of the piezoelectric ceramic plate 161, while the other longitudinal end of the groove 162 is gradually reduced in depth and does not extend to the other end surface of the piezoelectric ceramic plate 161. Electrodes 165 for application of a drive voltage are formed on opening-side surface of the opposite side walls 163 within each groove 162 is formed, the electrodes 165 extending along the longitudinal direction of the groove 162.

An ink chamber plate 167 is joined by an adhesive 169 to the thus-formed piezoelectric ceramic plate 161 at the groove 162 opening side. The ink chamber plate 167 has a common ink chamber 171 formed as its recess communicating with the shallow end portions of the grooves 162, and an ink supply port 172 formed through its portion between the bottom of the common ink chamber 171 and the surface opposite from the groove 162.

A nozzle plate 175 is joined to the end surface of the joined body formed of the piezoelectric ceramic plate 161 and the ink chamber plate 167 in which the grooves 162 form openings. Nozzle openings 177 are formed in the nozzle plate 175 at such positions as to respectively face the grooves 162.

The head chip is assembled by joining a nozzle support plate (not shown) for supporting the nozzle plate 175 to peripheral portions of the joined body formed of the piezoelectric ceramic plate 161 and the ink chamber plate 167.

A wiring substrate 180 is fixed to a surface portion of the piezoelectric ceramic plate 161 opposite from the nozzle plate 175 and opposite from the ink chamber plate 167. A wiring pattern 182 is formed on the wiring substrate 180 and connected to the electrodes 165 by bonding wires 181, a flexible printed circuit, or the like. A drive voltage can be applied to each electrode 165 through the wiring pattern 182.

The conventional ink jet head having the thus-formed head chip is manufactured, for example, by an unillustrated process including joining a flow passage substrate for supplying ink to the ink supply port 172 of the ink chamber plate 167, and thereafter joining a base plate etc. for holding the head chip and the wiring substrate 180 to the piezoelectric ceramic plate 161 in the joined body.

Note that, in the thus-obtained ink jet head, each groove 162 is filled with ink through the ink supply port 172. When predetermined driving electric fields are caused to act on the side walls 163 on the opposite sides of a predetermined one of the grooves 162 through the electrodes 165, the side walls 163 are deformed to change the capacity of the groove 162, thereby ejecting ink out of the predetermined groove 162 through the nozzle opening 177.

For example, as shown in FIG. 17, when ink is ejected through the nozzle opening 177 corresponding to the groove 162a, a positive drive voltage is applied to the electrodes 165a and 165b in the groove 162a while the electrodes 165c and 165d respectively opposed to the electrodes 165a and 165b are grounded. Driving electric fields are thereby caused to act on the side walls 163a and 163b in directions toward the groove 162a. If these directions are perpendicular to the direction of polarization of the piezoelectric ceramic plate 161, the side walls 163a and 163b deform along directions toward the groove 162a by a piezoelectric thickness shear effect to cause a reduction in the capacity of the groove 162a and, hence, an increase in pressure in the groove 162a, thereby ejecting ink through the nozzle opening 177.

If a solvent-based ink is used in the above-described conventional ink jet head, it is necessary to use an adhesive having a high hardness and insoluble in the solvent-based ink in manufacturing the ink jet head by joining other members, e.g., the nozzle support plate and the base plate to the piezoelectric ceramic plate.

In a case where a non-solvent-based ink is used in the above-described conventional ink jet head, an elastic adhesive having a low hardness can be used for joining of members to the piezoelectric ceramic plate even if the joined members have a large linear expansion coefficient. Such an adhesive absorbs differences between varying amounts of deformation, if any, due to thermal expansion or shrinkage to limit deformation in the piezoelectric ceramic plate.

However, in a case where a solvent-based ink is used in the above-described conventional ink jet head, and where the piezoelectric ceramic plate and other members are joined together by an adhesive having a high hardness, the piezoelectric ceramic plate is deformed due to the differences between the linear expansion coefficients of the piezoelectric ceramic plate and of the other members.

Specifically, the material forming the piezoelectric ceramic plate has a linear expansion coefficient smaller than those of the other members. Therefore, when the piezoelectric ceramic plate and the other members change in size by thermal expansion or shrinkage, the adhesive having a high hardness cannot absorb the differences between the amounts of deformation in the piezoelectric ceramic plate and the other members, resulting in a deformation in the piezoelectric ceramic plate.

Such deformation in the piezoelectric ceramic plate may cause a flaw, e.g., a crack in the piezoelectric ceramic plate or a misalignment between the nozzle openings and the grooves or the like, resulting in a product defect and a reduction in yield.

It is possible to limit such deformation in piezoelectric ceramic plate by using an adhesive having a low hardness. A low-hardness adhesive, however, is inferior in durability than a high-hardness adhesive under the presence of a solvent-based ink and therefore has a problem in that separation between the piezoelectric ceramic plate and the other members occurs at the joint by contact with the solvent-based ink.

### SUMMARY OF THE INVENTION

In view of these circumstances, an object of the present invention is to provide an ink jet head in which a solvent-based ink can be used and the amount of deformation in a piezoelectric ceramic plate is limited to ensure improved yield, and a method of manufacturing the ink jet head.

In order to achieve the above-mentioned object, according to a first aspect of the present invention, there is provided an ink jet head comprising a piezoelectric ceramic plate in which a plurality of grooves to be filled with a solvent-based ink are formed, and in which electrodes are formed on side walls of said grooves, an ink chamber plate joined to said piezoelectric ceramic plate and having a common ink chamber communicating with each of said grooves, a nozzle plate joined to an end surface of a joined body formed of said piezoelectric ceramic plate and said ink chamber plate in which the end surface has openings of said grooves, said nozzle plate having nozzle openings through each of which the solvent-based ink filling the corresponding groove is ejected, and a nozzle support plate provided around a peripheral portion of said joined body on the nozzle plate side, said ink jet head being characterized in that a spacer formed from a material having approximately the same linear expansion coefficient as that of the material of said piezoelectric ceramic plate is provided at least between the surfaces of said piezoelectric ceramic plate and said nozzle support plate to be joined to each other.

According to a second aspect of the present invention, in the first aspect of the invention, the ink jet head is characterized in that said spacer is joined by an adhesive insoluble in the solvent-based ink.

According to a third aspect of the present invention, in the first or the second aspect of the invention, the ink jet head is characterized by further comprising a base plate joined to said joined body on the piezoelectric ceramic plate side to hold said piezoelectric ceramic plate, and a flow passage substrate joined to said joined body on the ink chamber plate side to supply the solvent-based ink to said common ink chamber.

According to a fourth aspect of the present invention, in the third aspect of the invention, the ink jet head is characterized in that said spacer is provided between the surfaces of said piezoelectric ceramic plate in said joined body and said base plate to be joined to each other.

According to a fifth aspect of the present invention, in any one of the first to the fifth aspects of the invention, the ink jet head is characterized in that said spacer is provided between the surfaces of said ink chamber plate in said joined body and said nozzle support plate to be joined to each other.

According to a sixth aspect of the present invention, in any one of the third to fifth aspects of the invention, the ink jet head is characterized in that said spacer is provided between the surfaces of said ink chamber plate in said joined body and said flow passage substrate to be joined to each other.

According to a seventh aspect of the present invention, in any one of the first to the sixth aspects of the invention, the ink jet head is characterized in that said spacer is provided between the surfaces of said nozzle plate and nozzle support plate to be joined to each other.

According to an eighth aspect of the present invention, in any one of the first to the seventh aspects of the invention, the ink jet head is characterized in that said ink chamber plate is formed from a material having approximately the same linear expansion coefficient as that of the material of said piezoelectric ceramic plate.

According to a ninth aspect of the present invention, in any one of the first to the eighth aspects of the invention, the ink jet head is characterized in that the end surfaces of said joined body and said spacer to be joined to said nozzle plate are formed as a cut surface by cutting a joined substrate in which said joined body and said spacer are joined to each other, the end surfaces of said joined body and said spacer being flush with each other.

According to a tenth aspect of the present invention, in any one of the first to the ninth aspects of the invention, the ink jet head is characterized in that said base plate is formed from a material having approximately the same linear expansion coefficient as that of the material of said piezoelectric ceramic plate.

According to an eleventh aspect of the present invention, in any one of the first to the tenth aspects of the invention, the ink jet head is characterized in that each of said nozzle support plate and said flow passage substrate is formed from a material having approximately the same linear expansion coefficient as that of the material of said piezoelectric ceramic plate.

According to a twelfth aspect of the present invention, there is provided an ink jet head comprising a piezoelectric ceramic plate in which a plurality of grooves to be filled with a solvent-based ink are formed, and in which electrodes are formed on side walls of said grooves, an ink chamber plate joined to said piezoelectric ceramic plate and having a common ink chamber communicating with each of said grooves, a nozzle plate joined to an end surface of a joined body formed of said piezoelectric ceramic plate and said ink chamber plate in which the end surface has openings of said grooves, said nozzle plate having nozzle openings through each of which the solvent-based ink filling the corresponding groove is ejected, and a nozzle support plate provided around a peripheral portion of said joined body on the nozzle plate side, said ink jet head being characterized in that each of said nozzle support plate and said ink chamber plate is formed from a material having approximately the same linear expansion coefficient as that of the material of said piezoelectric ceramic plate and is joined by an adhesive insoluble in the solvent-based ink.

According to a thirteenth aspect of the present invention, in the twelfth aspect of the invention, the ink jet head is characterized by further comprising a base plate joined to said joined body on the ceramic plate side to hold the piezoelectric ceramic plate, said base plate being formed from a material having approximately the same linear expansion coefficient as that of the material of said piezoelectric ceramic plate.

According to a fourteenth aspect of the present invention, in the twelfth or the thirteenth aspect of the invention, the ink jet head is characterized by further comprising a flow passage substrate joined to said joined body on the ink chamber plate side to supply the solvent-based ink to said common ink chamber, said flow passage substrate being formed from a material having approximately the same linear expansion coefficient as that of the material of said piezoelectric ceramic plate.

According to a fifteenth aspect of the present invention, there is provided a method of manufacturing an ink jet head having a piezoelectric ceramic plate in which a plurality of grooves to be filled with a solvent-based ink are formed, and in which electrodes are formed on side walls of the grooves, an ink chamber plate joined to the piezoelectric ceramic plate and having a common ink chamber communicating with each of the grooves, a nozzle plate joined to an end surface of a joined body formed of the piezoelectric ceramic plate and the ink chamber plate in which the end surface has openings of said grooves, the nozzle plate having nozzle openings through each of which the solvent-based ink filling the corresponding groove is ejected, and a nozzle support plate provided around a peripheral portion of the joined body on the nozzle plate side, said method being characterized by comprising a step of forming a joined substrate by joining together a piezoelectric ceramic plate wafer in which a plurality of the grooves are formed and an ink chamber plate wafer in which a plurality of the common ink chambers are formed, and by joining a spacer wafer to the piezoelectric ceramic plate wafer on the side opposite from the side on which the ink chamber plate wafer is joined and at least in a region where the nozzle support plate is joined, the spacer wafer serving as a spacer and being formed from a material having approximately the same linear expansion coefficient as that of the material of the piezoelectric ceramic plate being formed from the spacer wafer, a step of cutting the joined substrate to form the end surface to be joined to the nozzle plate, a step of joining the nozzle plate to the joint end surface and joining the nozzle support plate to the joined body with the spacer interposed between the nozzle support plate and the joined body.

According to a sixteenth aspect of the present invention, in the fifteenth aspect of the invention, a method of manufacturing the ink jet head is characterized in that the spacer is joined by an adhesive insoluble in the solvent-based ink.

According to a seventeenth aspect of the present invention, in the fifteenth or the sixteenth aspect of the invention, a method of manufacturing the ink jet head is characterized by further comprising a step of joining to the joined body on the piezoelectric ceramic plate side a base plate for holding the piezoelectric ceramic plate, and joining to the joined body on the ink chamber plate side a flow passage substrate for supplying the solvent-based ink to the common ink chamber.

According to an eighteenth aspect of the present invention, in the seventeenth aspect of the invention, a method of manufacturing the ink jet head is characterized in that said step of forming the joined substrate comprises joining the spacer wafer also between the surfaces of the piezoelectric ceramic plate in the piezoelectric ceramic plate wafer and the base plate to be joined to each other, and said step of joining the base plate comprises joining the piezoelectric ceramic plate and the base plate with the spacer interposed therebetween.

According to a nineteenth aspect of the present invention, in the seventeenth or the eighteenth aspect of the invention, a method of manufacturing the ink jet head is characterized in that said step of forming the joined substrate comprises joining the spacer wafer also between the surfaces of the ink chamber plate in the ink chamber plate wafer and the nozzle support plate to be joined to each other, and said step of joining the nozzle support plate comprises joining the ink chamber plate and the nozzle support plate with the spacer interposed therebetween.

According to a twentieth aspect of the present invention, in any one of the seventeenth to the nineteenth aspects of the invention, a method of manufacturing the ink jet head is characterized in that said step of forming the joined substrate comprises joining the spacer wafer also between the surfaces of the ink chamber plate in the ink chamber plate wafer and the flow passage substrate to be joined to each other, and said step of joining the nozzle support plate comprises joining the ink chamber plate and the flow passage substrate with the spacer interposed therebetween.

According to a twenty-first aspect of the present invention, in any one of the fifteenth to the twentieth aspects of the invention, a method of manufacturing the ink jet head is characterized in that the nozzle plate and the nozzle support are joined to each other with the spacer interposed therebetween.

According to a twenty-second aspect of the present invention, in any one of the seventeenth to the twenty-first aspects of the invention, a method of manufacturing the ink jet head is characterized in that each of the material forming the base plate has approximately the same linear expansion coefficient as that of the material of the piezoelectric ceramic plate.

According to a twenty-third aspect of the present invention, in any one of the seventeenth to the twenty-second aspects of the invention, a method of manufacturing the ink jet head is characterized in that the material forming the nozzle support plate and the flow passage substrate has approximately the same linear expansion coefficient as that of the material of the piezoelectric ceramic plate.

According to a twenty-fourth aspect of the present invention, in any one of the fifteenth to the twenty-third aspects of the invention, a method of manufacturing the ink jet head is characterized in that the material forming the ink chamber plate has approximately the same linear expansion coefficient as that of the material of the piezoelectric ceramic plate.

In the present invention described above, a spacer formed from a material having approximately the same linear expansion coefficient as that of the material of the piezoelectric ceramic plate is provided at least between the surfaces of the piezoelectric ceramic plate and the nozzle support plate to be joined to each other, thereby reliably limiting deformation in the piezoelectric ceramic plate due to the differences between the amounts of deformation by thermal expansion or shrinkage in the members constituting the ink jet head. Therefore it is possible to reduce ink jet head product defects and to thereby improve the yield.

### BRIEF DESCRIPTION OF THE DRAWINGS

For a more better understanding of the present invention, reference is made of a detailed description to be read in conjunction with the accompanying drawings, in which:

FIG. 1 is a perspective view of an ink jet head according to Embodiment 1 of the present invention;

FIG. 2 is a cross-sectional view of an essential portion of the ink jet head according to Embodiment 1 of the present invention;

FIG. 3 is an exploded perspective view and a sectional perspective view of the head chip according to Embodiment 1 of the present invention;

FIG. 4 is an enlarged cross-sectional view of the essential portion of the ink jet head according to Embodiment 1 of the present invention;

FIG. 5 is a diagram for explaining process steps for manufacturing a piezoelectric ceramic plate according to Embodiment 1 of the present invention;

FIG. 6 is a diagram for explaining process steps for manufacturing an ink chamber plate according to Embodiment 1 of the present invention;

FIG. 7 is a diagram for explaining process steps for manufacturing a joined member according to Embodiment 1 of the present invention;

FIG. 8 is a perspective view of the joined member according to Embodiment 1 of the present invention;

FIG. 9 is a diagram for explaining process steps for manufacturing an ink jet head according to Embodiment 1 of the present invention;

FIG. 10 is an enlarged cross-sectional view of an essential portion of an ink jet head according to Embodiment 2 of the present invention;

FIG. 11 is an enlarged cross-sectional view of an essential portion of an ink jet head according to Embodiment 3of the present invention;

FIG. 12 is an enlarged cross-sectional view of an essential portion of an ink jet head according to another embodiment of the present invention;

FIG. 13 is a perspective view of a carriage according to Embodiment 1 of the present invention;

FIG. 14 is a schematic perspective view of an ink jet recording apparatus according to Embodiment 1 of the present invention;

FIG. 15 is a schematic perspective view of a head chip according to a conventional art;

FIG. 16 is a schematic cross-sectional view of the head chip according to the conventional art; and

FIG. 17 is a schematic cross-sectional view of the head chip according to the conventional art.

### DETAILED DESCRIPTION OF THE PREFERED EMBODIMENT

Hereinafter, the detailed description of the present invention will be made based on embodiments of the invention.

(Embodiment 1)

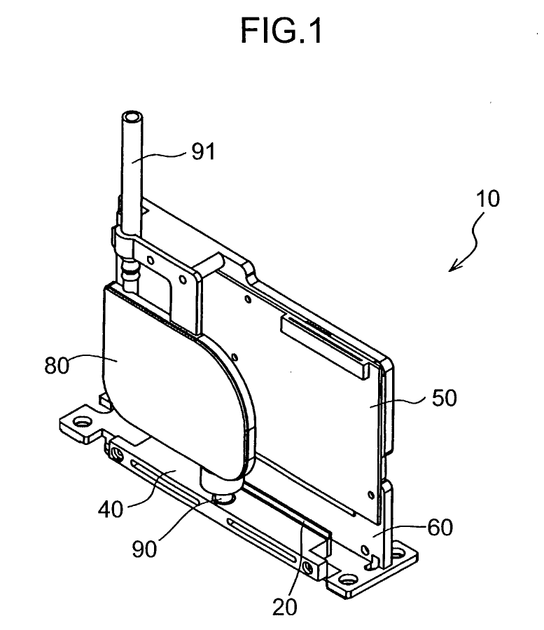

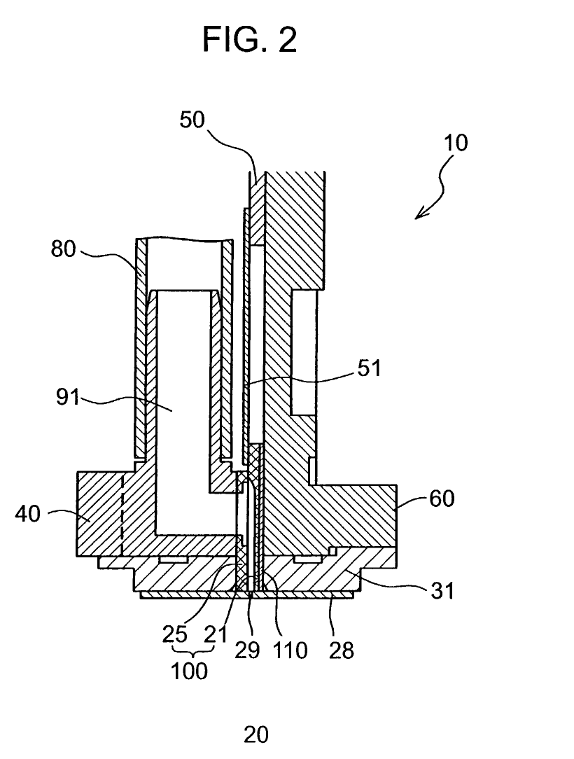

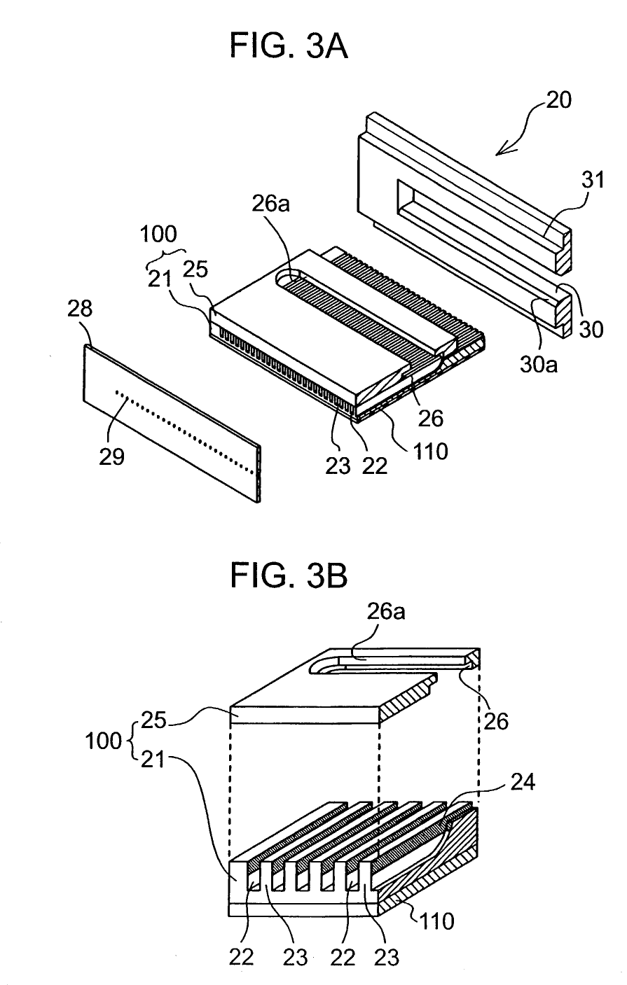

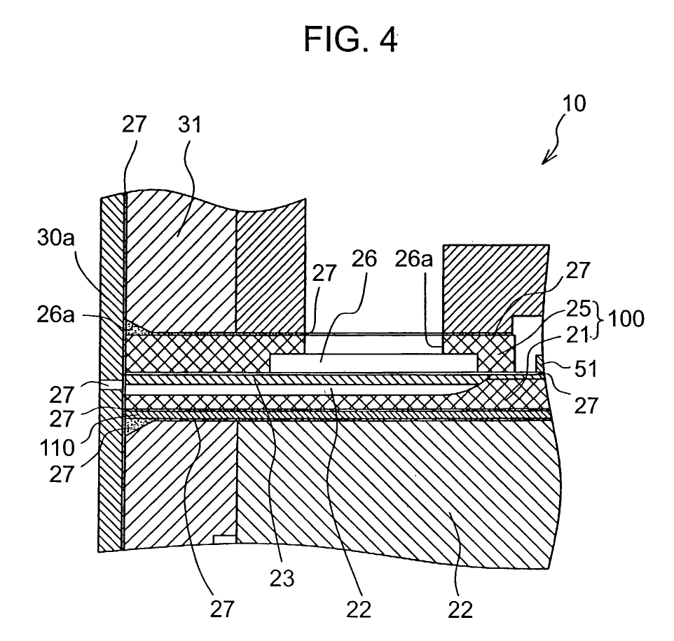

FIG. 1 is a perspective view of an ink jet head according to Embodiment 1 of the present invention; FIG. 2 is a cross-sectional view of an essential portion of the ink jet head; FIG. 3 comprises an exploded perspective view and a sectional perspective view of the head chip; and FIG. 4 is an enlarged cross-sectional view of the essential portion of the ink jet head.

As illustrated in the drawing, the ink jet head 10 of this embodiment has a head chip 20, a flow passage substrate 40 provided on one side of the head chip 20, and a wiring substrate 50 on which a drive circuit for driving the head chip 20, etc., are provided. These members are fixed on a base plate 60.

A plurality of grooves 22 which communicate with nozzle openings 29 are formed in parallel with each other in a piezoelectric ceramic plate 21 constituting the head chip 20. The grooves 22 are isolated from each other by side walls 23. One longitudinal end of each groove 22 extends to one end surface of the piezoelectric ceramic plate 21, while the other longitudinal end of the groove 22 is gradually reduced in depth and does not extend to the other end surface of the piezoelectric ceramic plate 21. Electrodes 24 for application of a drive voltage are formed on opening-side portions of the opposite side walls 23 between which one groove 22 is formed, the electrodes 24 extending along the longitudinal direction of the groove 22.

Each of the grooves 22 to be formed in the piezoelectric ceramic plate 21, as will be described below in detail, is formed, for example, by a disk-shaped dice cutter, and its portion gradually reduced in depth is formed in the shape corresponding to that of the dice cutter. The electrodes 24 in each groove 22 are formed by, for example, well-known vapor deposition in slanting directions.

Conductors in external wiring 51 such as a flexible printed cable (FPC) are connected at their one end to the electrodes 24 thus formed on the opening-side portions of the side walls 23 between which the grooves 22 are formed. The wiring conductors are connected at their other end to a drive circuit (not shown) on the wiring substrate 50. Thus, the electrodes 24 are electrically connected to the drive circuit.

An ink chamber plate 25 is joined to the thus-formed piezoelectric ceramic plate 21 at the groove 22 opening side. The ink chamber plate 25 has a common ink chamber 26 communicating with each groove 22, and an ink supply port 26a which communicates with the common ink chamber 26, and through which a solvent-based ink is supplied to each groove 22.

In this embodiment, since each groove 22 is filled with a solvent-based ink through the common ink chamber 26, the piezoelectric ceramic plate 21 and the ink chamber plate 25 are joined to each other by an adhesive 27 having a high hardness and insoluble in the solvent-based ink.

Note that high-hardness adhesive 27 is an adhesive having a high hardness after setting and a high resistance to solvents. In this embodiment, an adhesive having a Shore hardness D of 85 to 90° is used as high-hardness adhesive 27.

In this embodiment, since the piezoelectric ceramic plate 21 and the ink chamber plate 25 are joined by high-hardness adhesive 27, a ceramic plate having a linear expansion coefficient close to that of the piezoelectric ceramic plate 21 is used as a member forming the ink chamber plate 25 in order that the amount of deformation in the ink chamber plate 25 due to thermal expansion or shrinkage be approximately equal to that of the piezoelectric ceramic plate 21.

A nozzle plate 28 is joined to the end surface of the joined body 100 formed of the piezoelectric ceramic plate 21 and the ink chamber plate 25 in which the grooves 22 form openings. Nozzle openings 29 are formed in the nozzle plate 28 at such positions as to respectively face the grooves 22.

In this embodiment, the nozzle plate 28 is larger than the area of the end surface of the joined body formed of the piezoelectric ceramic plate 21 and the ink chamber plate 25 in which the grooves 22 have their openings. The nozzle plate 28 is, for example, a polyimide film in which nozzle openings 29 are formed by using an excimer laser.

An unillustrated water-repellent film having water repellency is formed on the surface of the nozzle plate 28 opposed to a printing medium to prevent attachment of solvent-based ink or the like.

The nozzle plate 28 thus formed and the joined body 100 are also joined to each other by high-hardness adhesive 27 insoluble in the solvent-based ink.

A nozzle support plate 31 having an engagement hole 30 for engagement with the joined body 100 is joined to peripheral surfaces of the joined body 100 at the end surface of the same in which grooves 22 have their openings. The nozzle support plate 31 has tapered portions 30a at the engagement hole 30 such that the opening area is gradually increased along the direction toward one side. In this embodiment, aluminum (Al) is used as the material for forming the nozzle support plate 31.

One side surface of the nozzle support plate 31 is fitted and bonded to the surface of the nozzle plate 28 outside the end surface of the joined body 100. That is, the nozzle support plate 31 supports the nozzle plate 28.

Thus, the head chip 20 constituted by the piezoelectric ceramic plate 21, the ink chamber plate 25, the nozzle plate 28, and the nozzle support plate 31 is assembled.

Note that, in this embodiment, the tapered portions 30a are provided in the nozzle support plate 31 to enable the nozzle plate 28, the nozzle support plate 31 and the joined body 100 to be firmly joined to each other in such a manner that internal spaces along the tapered portions 30a are filled with high-hardness adhesive 27, as will be described below in detail. The rigidity of the head chip 20 is thereby increased.

Here, for example, in a case where lead zirconate titanate (PZT) is used as the material of the piezoelectric ceramic plate 21, the piezoelectric ceramic plate 21 is deformed by thermal expansion or shrinkage of the nozzle support plate 31, because the nozzle support plate 31 is formed from aluminum (Al) having a linear expansion coefficient of 24×10×−6/° C. while the linear expansion coefficient of PZT is 4 to 9×10−6/° C., and because the piezoelectric ceramic plate 21 and the nozzle support plate 31 are joined to each other by high-hardness adhesive 27 insoluble in the solvent-based ink. For example, under a condition of 60 to 70° C., the piezoelectric ceramic plate 21 is deformed by about 30 to 70 μm.

In this embodiment, therefore, a spacer 110 formed from a material having approximately the same linear expansion coefficient as that of the material of the piezoelectric ceramic plate 21 is provided on the entire surface of the piezoelectric ceramic plate 21 opposite from the surface joined to the ink chamber plate 25. That is, the nozzle support plate 31 and the base plate 60 are jointed to the piezoelectric ceramic plate 21 by high-hardness adhesive 27 with the spacer 110 interposed therebetween.

Note that this spacer 110 absorbs stress due to deformation caused by thermal expansion or shrinkage of the nozzle support plate 31 and the base plate 60 to limit deformation in piezoelectric ceramic plate 21.

There is no particular restriction on the selection of the material forming this spacer 110 except that a linear expansion coefficient approximately-equal to that of PZT is required. For example, quartz or alumina (Al2O3) or the like may be used as the material of the spacer 110. In this embodiment, alumina (Al2O3) having a linear expansion coefficient of 6 to 8×10−6/° C., for example, is used. The thickness of the spacer 110 is, for example, about 0.1 to 1.5 mm and, preferably, 0.6 mm or greater.

Thus, the spacer 110 having approximately the same linear expansion coefficient as that of the piezoelectric ceramic plate 21 is provided to limit deformation in the piezoelectric ceramic plate 21 when the nozzle support plate 31 and the base plate 60 expand. Needless to say, the spacer 110 also has the function of limiting deformation in the base plate 60.

Therefore it is possible to reliably prevent occurrence of a flaw e.g., a crack in the piezoelectric ceramic plate 21 or a misalignment between the nozzle openings 29 and the grooves 22 due to deformation in the piezoelectric ceramic plate 21. Consequently, it is possible to reliably prevent occurrence of a product defect and to thereby improve the yield.

In this embodiment, a plurality of joined bodies 100 each constituting the head chip 20 and having the spacer 110 joined thereto are simultaneously formed by joining a plurality of wafers and by cutting the joined wafers, as will be described below in detail. Therefore, the joint end surface to the nozzle plate 28 of the joined body 100 having the spacer 110 joined thereto is a cut surface in which joined substrates obtained by joining the wafers each formed as the piezoelectric ceramic plate 21, the ink chamber plate 25 and the spacer 110 are cut so that the end surface of the joined body 100 and the end surface of the spacer 110 are flush with each other.

Therefore there is, for example, no protrusion or the like of the adhesive on the end surface of the joined body 100 and the spacer 110 in which the grooves 22 have their openings, so that the joined body 100 and the spacer 110 can be reliably joined to the nozzle plate 28 without misalignment.

A flow passage substrate 40 such as shown in FIG. 2 is joined to the ink chamber plate 25 at one side of the same by high-hardness adhesive 27. The common ink chamber 26 is closed at one side in a sealing manner with the flow passage substrate 40.

More specifically, the flow passage substrate 40 abuts on one side surface of the ink chamber plate 25 with an O-ring or the like interposed therebetween, and is fixed on the base plate 60 by screw members or the like, not shown. Thus, high-hardness adhesive 27 is used to prevent the joint portions of the ink chamber plate 25 and the flow passage substrate 40 from separating from each other due to contact with the solvent-based ink.

The material forming this flow passage substrate 40 is, preferably, a material having a linear expansion coefficient approximately equal to that of PZT. Such a material is used for the purpose of limiting deformation in the ink chamber plate 25. In this embodiment, polyphenylene sulfide (PPS) is used as a material forming the flow passage substrate 40.

On the other hand, the base plate 60 for holding the head chip 20 is joined by high-hardness adhesive 27 and through the spacer 110 to the surface of the piezoelectric ceramic plate 21 opposite from the surface to which the ink chamber plate 25 is joined.

The spacer 110 is thus used to prevent the piezoelectric ceramic plate 21 from being deformed due to the difference between the linear expansion coefficients of the piezoelectric ceramic plate 21 and the base plate 60.

The surface of an end portion of the above-mentioned wiring substrate 50 opposite from the surface on which connections to the piezoelectric ceramic plate 21 are made is joined to the surface of the base plate 60 to which the piezoelectric ceramic plate 21 is joined.

In this embodiment, aluminum (Al) is used as a material forming the base plate 60.

A connection portion 41 to which one end of an ink communication pipe 90 made of a stainless steel pipe or the like is connected is formed on the upper surface of the flow passage substrate 40. A negative pressure regulating part 80 which is connected to an ink tank such as an ink cartridge by an ink supply pipe 91 and in which a predetermined amount of the solvent-based ink is temporarily stored is connected to the other end of the ink communication pipe 90.

The negative pressure regulating part 80 is provided for pressure regulation of the solvent-based ink in the common ink chamber 26 and the grooves 22 in the head chip 20. That is, there is a risk of the pressure in the head chip 20 being changed to break the meniscus formed in nozzle opening 29 by the surface tension of the solvent-based ink when the ink jet head 10 moves in the main scanning direction. This change in pressure in the head chip 20 is regulated by the pressure regulating part 80 to thereby maintain the meniscus with stability and to enable ejection of the solvent-based ink. Also, since the negative pressure regulating part 80 stores a predetermined amount of the solvent-based ink therein, it contributes to bubble storage effective in preventing bubbles in the input supply pipe 91 from mixing in the ink in the head chip 20.

As described above, the ink jet head 10 of this embodiment has the spacer 110 which is formed from a material having a linear expansion coefficient approximately equal to that of the material of the piezoelectric ceramic plate 21, and which is provided between the surface of the piezoelectric ceramic plate 21 and the joint surface of the nozzle support plate 31 and the base plate 60 by high-hardness adhesive 27, with the spacer 110 and the joint surfaces being jointed to each other, thereby limiting deformation in the piezoelectric ceramic plate 21 while maintaining the strong joint insoluble in the solvent-based ink.

On the other hand, the ink chamber plate 25 is formed from a material having a linear expansion coefficient approximately equal to that of the material of the piezoelectric ceramic plate 21. Therefore the ink chamber plate 25 functions like the spacer 110 between the piezoelectric ceramic plate 21 and the nozzle support plate 31 to limit deformation in the piezoelectric ceramic plate 21.

Consequently, the deformation in piezoelectric ceramic plate 21 constituting the head chip 20 can be limited with reliability to enable reducing product defects in ink jet heads 10 and improving yield.

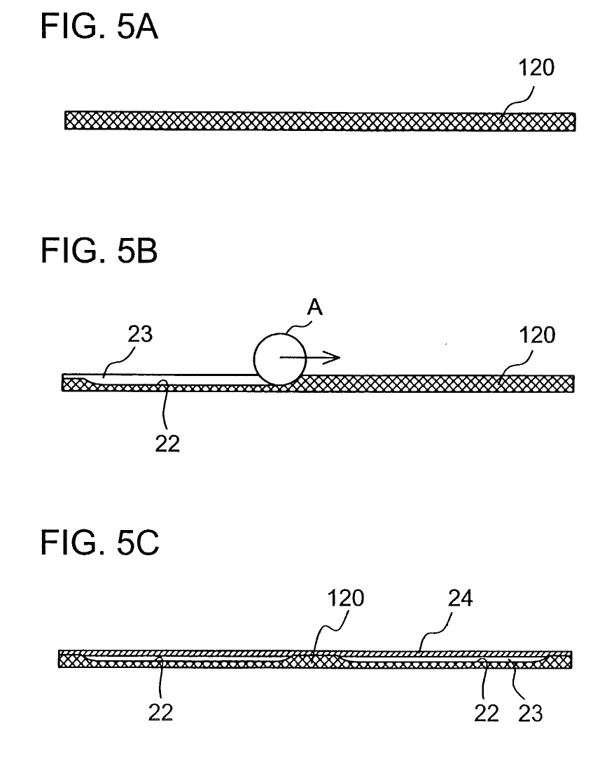

A method of manufacturing the above-described ink jet head 10 will be described in detail with reference to FIGS. 5 to 9. FIGS. 5 to 9 are diagrams showing steps in the process of manufacturing the ink jet head according to Embodiment 1 of the present invention.

First, as shown in FIGS. 5(a) and 5(b), a plurality of grooves 22 are formed in one surface of a piezoelectric ceramic plate wafer 120 from which piezoelectric ceramic plates 21 are formed.

In this embodiment, a disk-shaped dice cutter A, for example, is used to cut in the depth direction one surface of the piezoelectric ceramic plate wafer 120 formed from lead zirconate titanate (PZT). Then, a plurality of grooves 22 are formed in the one surface of the piezoelectric ceramic plate wafer 120 at certain intervals in the cutting direction of the dice cutter A. Note that these plurality of grooves 22 are formed so as to be arranged in the one surface of the piezoelectric ceramic plate wafer 120, although this arrangement is not illustrated in the drawing.

Thereafter, electrodes 24 are formed on side walls 23 of each groove 22 by well-known deposition in slanting directions, as shown in FIG. 5(c).

Note that the piezoelectric ceramic plate wafer 120 in which grooves 22 are thus formed is cut at plurality of positions along a direction perpendicular to the cutting direction of the dice cutter A in a process step performed afterward. Each groove 22 is separated into halves by this cutting.

Next, a plurality of common ink chambers 26 and a plurality of ink supply ports 26a are formed on an ink chamber plate wafer 121 from which ink chamber plates 25 are formed.

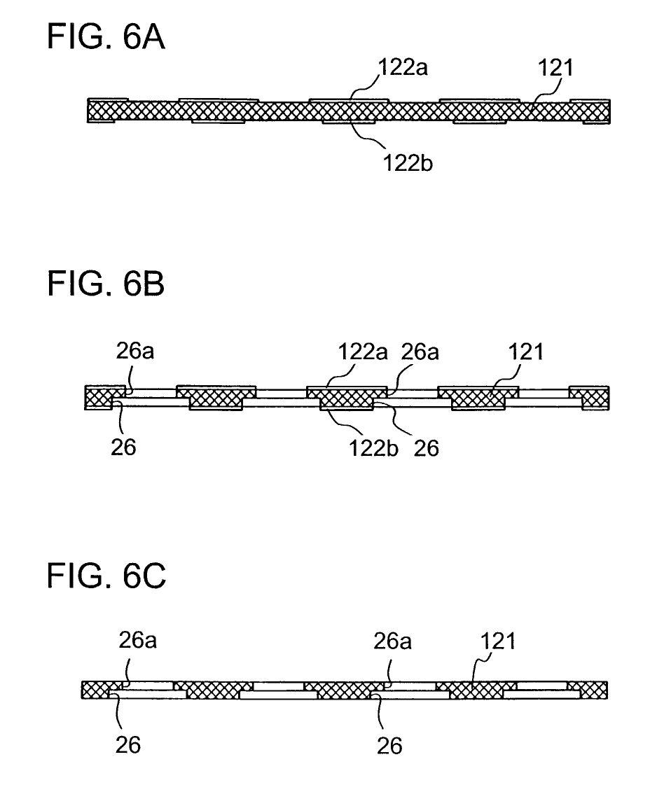

More specifically, as shown in FIG. 6(a), predetermined resist patterns 122a and 122b are first formed on both surfaces of the ink chamber plate wafer 121.

Subsequently, as shown in FIG. 6(b), portions of the ink chamber plate wafer 121 not covered with the resist patterns 122a and 122b are subjected to, for example, sandblasting to form common ink chambers 26 and ink supply ports 26a at such positions that each groove 22 in the piezoelectric ceramic plate wafer 120 faces two common ink chambers 26 and two ink supply ports 26a.

Thereafter, the resist patterns 122a and 122b are removed, as shown in FIG. 6(c).

The piezoelectric ceramic plate wafer 120 and the ink chamber plate wafer 121 formed by the above-described steps and a spacer wafer 123 from which spacers 110 are formed are joined to each other to form a joined substrate 130.

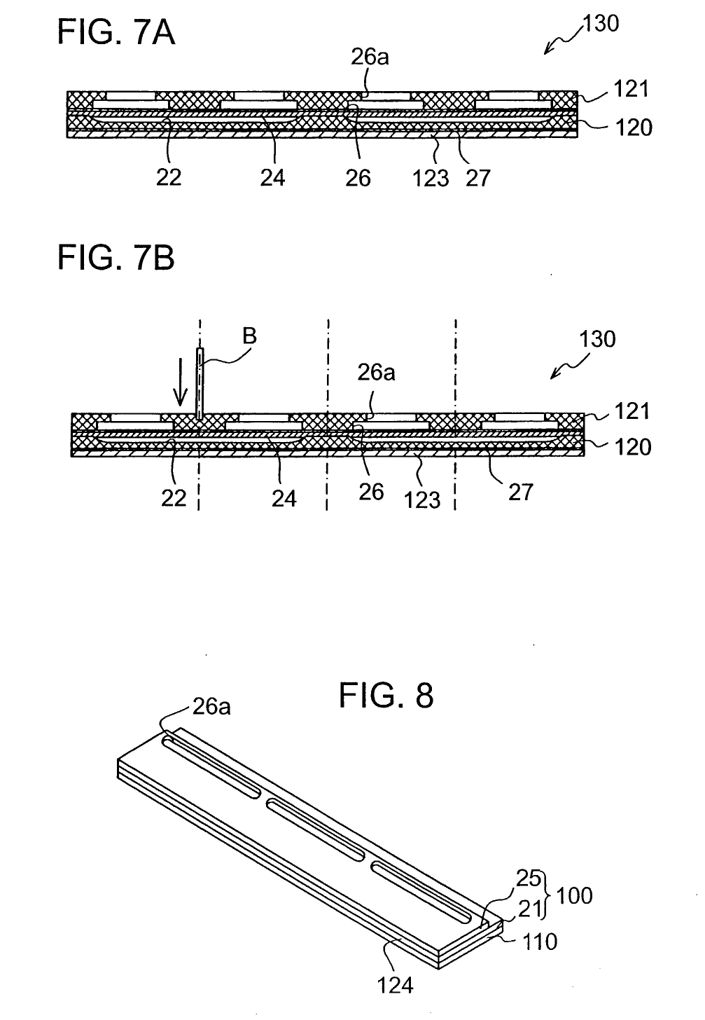

More specifically, as shown in FIG. 7(a), the piezoelectric ceramic plate wafer 120 is first sandwiched between the ink chamber plate wafer 121 and the spacer wafer 123 with high-hardness adhesive 27 provided therebetween. These members are maintained in this state under a 90° C. temperature condition and under a predetermined pressure for five hours, followed by drying. The joined substrate 130 is thus formed.

At this time, in this embodiment, each groove 22 is continuously formed through the region corresponding to the joint portion to which the nozzle support plate 31 is joined. In the process step performed afterward, each groove 22 is separated into halves by cutting to form a cut surface. Note that, in this embodiment, alumina is used as a material for forming this spacer wafer 123.

In this embodiment, as described, piezoelectric ceramic plate wafer 120, the ink chamber plate wafer 121 and the spacer wafer 123 are joined in a wafer state. Therefore the wafers can be uniformly joined to each other.

Subsequently, the joined substrate 130 is cut as shown in FIG. 7(b) to form joined bodies 100, such as shown FIG. 8, each having the spacer 110 joined thereto.

In this embodiment, a dice cutter B, for example, is used to cut the joined substrate 130, including the spacer wafer 123, between each adjacent pair of the common ink chambers 26 with the ink supply port 26a in the ink chamber plate wafer 121, thereby forming joined bodies 100 having the spacer 110 joined thereto.

That is, each of the above-described grooves 22 is separated into halves by cutting and the spacer wafer 123 joined through the region to be separated by cutting is also cut. Then, a cut surface 124, which is formed of end surfaces of the piezoelectric ceramic plate 21 and the ink chamber plate 25, and an end surface of the spacer 110, that is, an end surface to be joined to the nozzle plate 28, is formed so that the end surfaces therein are flush with each other.

Next, a head chip 20 is assembled by integrally joining the joined body 100 to which the above-described spacer 110 has been joined, the nozzle plate 28, and the nozzle support plate 31.

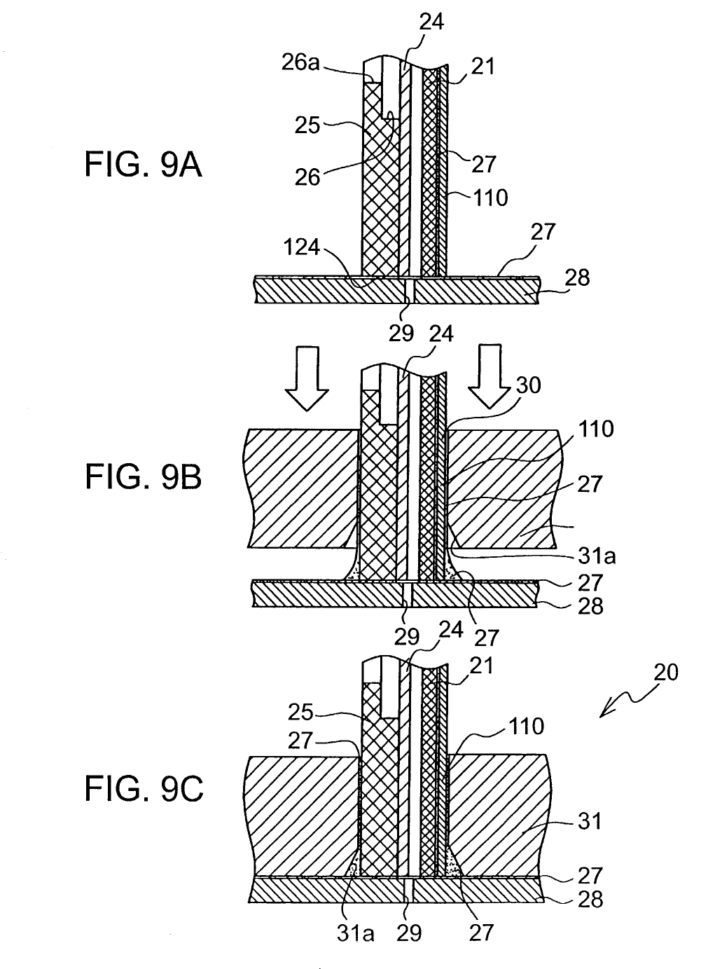

More specifically, as shown in FIG. 9(a), the nozzle plate 28 and the joined body 100 with the spacer 110 are first joined to each other by using high-hardness adhesive 27 so that the nozzle openings of the nozzle plate 28 and the grooves 22 having their openings in the end surface of the joined body 100 communicate with each other.

At this time, in this embodiment, since the end surfaces of the joined body 100 and the spacer 110 are formed as cut surface 124 such that no protrusion of the adhesive or the like, no protrusion of the spacer 110 due to positioning failure, or the like exists on the cut surface 124, the joined body 100 with the spacer 110 joined thereto can be perpendicularly brought into abutment on the portion of the nozzle plate 28 on the peripheries of the nozzle openings 29 and can be joined to this portion with reliability.

Subsequently, as shown in FIG. 9(b), after high-hardness adhesive 27 is applied to external surfaces of the joined body 100 and the spacer 110 at the nozzle plate 28 side, the joined body 100 with the spacer 110 joined thereto is pressed against the nozzle plate 28 at a predetermined pressure while being engaged in the engagement hole 30 of the nozzle support plate 31.

In this manner, as shown in FIG. 9(c), peripheral portions of the joined body 100 and the spacer 110 at the cut surface 124 side are joined to the inner surface of the engagement hole 30 of the nozzle support plate 31 by high-hardness adhesive 27, and the nozzle plate 28 and the nozzle plate 31 are also joined to each other.

At this time, in this embodiment, high-hardness adhesive 27 applied to the peripheral portions of the joined body 100 and the spacer 110 around the joint portions joined to the nozzle plate 28 forms a filling on the tapered portions 30a of the nozzle support plate 31 at the opening of the engagement hole 30. Thus, the nozzle plate 28 and the nozzle support plate 31 can be firmly bonded to the joined body 100 and to the spacer 110.

Thus, the nozzle plate 28, the nozzle support plate 31, the joined body 100 and the spacer 110 are integrally joined to each other to complete the head chip 20.

The above-described flow passage substrate 40 and the base plate 60, etc., are joined to the head chip 20 to complete the ink jet head 10. That is, in this embodiment, the nozzle support plate 31 and the ink chamber plate 25 are joined to each other by high-hardness adhesive 27, and the base plate 60 and the spacer 110 joined to the piezoelectric ceramic plate 21 are joined to each other by high-hardness adhesive 27, thus completing the ink jet head 10 of this embodiment (see FIG. 2).

In this way, since the piezoelectric ceramic plate 21, the nozzle support plate 31, and the base plate 60 are joined to each other together with the spacer by high-hardness adhesive 27, high-hardness adhesive 27 is not dissolved even in a case where the scattered solvent-based ink is attached to the joint therebetween when the ejection-side surface of the nozzle plate 28 is wiped. Therefore the ink jet head can also have improved reliability.

(Embodiment 2)

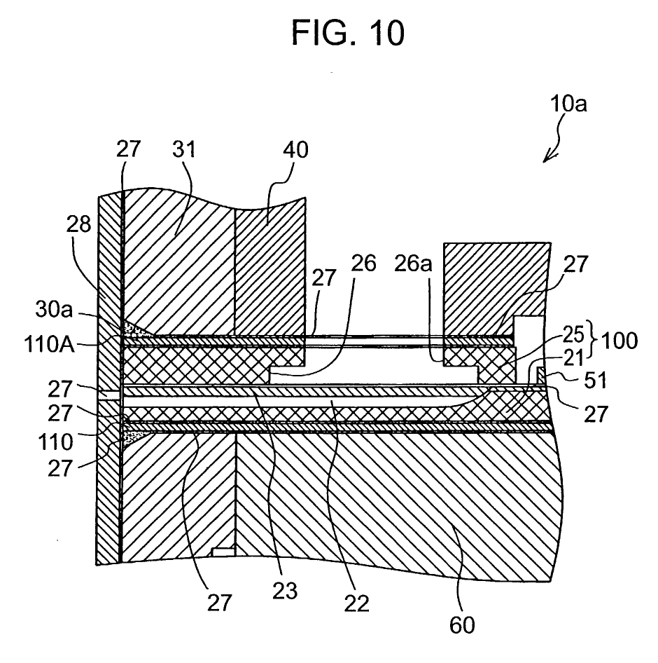

FIG. 10 is an enlarged cross-sectional view of main components of members an ink jet head according to Embodiment 2 of the present invention.

As illustrated in the drawing, the ink jet head 10A of this embodiment has the spacer 110 of the above-described Embodiment 1 and a spacer 110A provided between the surface of the ink chamber plate 25 and the surfaces of the nozzle support plate 31 and the flow passage substrate 40 to be joined to each other, the spacer 110A being formed from a material having a linear expansion coefficient approximately equal to that of the material of the piezoelectric ceramic plate 21.

Each of these spacers 110 and 110A is joined by using high-hardness adhesive 27 insoluble in the solvent-based ink, as in the above-mentioned Embodiment 1.

In this way, in this embodiment, the spacer 110A is also provided between the surface of the ink chamber plate 25 of the joined body 100 and the surfaces of the nozzle support plate 31 and the flow passage substrate 40 to be joined to each other, thereby limiting deformation in the piezoelectric ceramic plate 21 further effectively. That is, since the piezoelectric ceramic plate 21 and the ink chamber plate 25 are respectively formed from materials having linear expansion coefficients approximately equal to each other, there is a risk of the ink chamber plate 25 being deformed by deformation due to thermal expansion or shrinkage of the nozzle support plate 31 and the flow passage substrate 40. However, such deformation can be absorbed by the spacer 110A. Thus, the influence of such deformation on the piezoelectric ceramic plate 21 joined to the ink chamber plate 25 can be reduced with reliability.

Further, the joined body 100 formed of the piezoelectric ceramic plate 21 and the ink chamber plate 25 is sandwiched between the spacers 110 and 110A, so that influences from any of the members constituting the ink jet head 10 other than the joined body 100 can be reduced in well balance.

Thus, deformation in piezoelectric ceramic plate 21 can be advantageously limited and an improvement in stability with which the solvent-based ink is ejected can be expected.

The spacer 110A is provided between the surface of the ink chamber plate 25 and the surfaces of the nozzle support plate 31 and the flow passage substrate 40 to be joined to each other. The need for using PPS as the material forming the flow passage substrate 40 by considering the influence of deformation in the ink chamber plate 25 on the piezoelectric ceramic plate 21 is thereby eliminated to enable the flow passage substrate 40 to be formed from a material other than PPS.

Further, in this embodiment, spacer wafers from which spacers 110 and 110A are formed are respectively joined to a piezoelectric ceramic plate wafer and an ink chamber plate wafer to form a joined substrate, and this joined substrate is cut as in the above-described Embodiment 1, so that the end surface of the joined body 100 and the end surfaces of the spacers 110 and 110A can easily be formed so as to be flush with each other. Consequently, the joined body 100 to which the spacers 110 and 110A have been joined can be reliably joined to the nozzle plate 28 in a state of perpendicularly abutting against the nozzle plate 28.

(Embodiment 3)

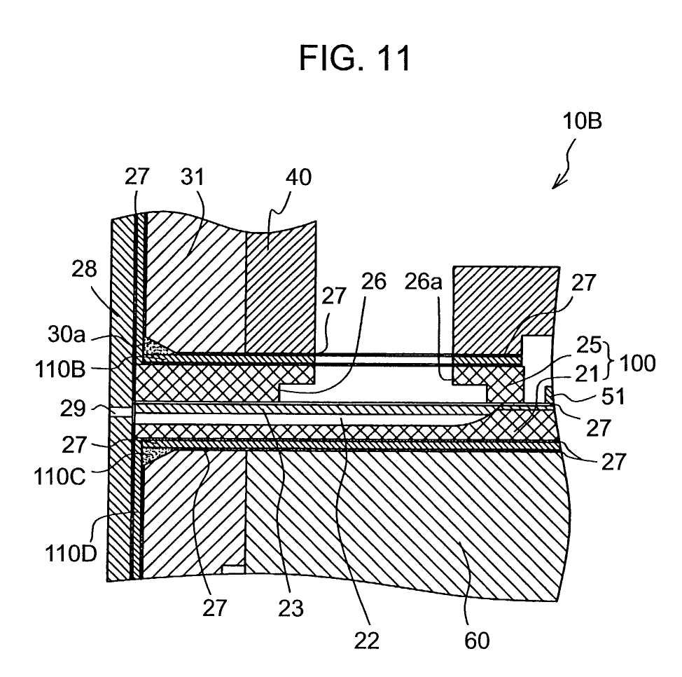

FIG. 11 is an enlarged cross-sectional view of main components of members an ink jet head according to Embodiment 3 of the present invention.

As illustrated in the drawing, the ink jet head 10B of this embodiment has spacers 110B and 110C between which the joined body 100 formed of the piezoelectric ceramic plate 21 and the ink chamber plate 25 is sandwiched, and also has a spacer 110D provided between the surfaces of the nozzle plate 28 and the nozzle support plate 31 to be joined to each other.

Each of these spacers 110B to 110D is joined by using high-hardness adhesive 27 insoluble in the solvent-based ink, as in Embodiment 1.

In this way, in this embodiment, the spacers 110B to 110D are provided between all the joint surfaces in the ink jet head 10B and the members are joined to each other by high-hardness adhesive 27, and the high-hardness adhesive 27 is not dissolved in the solvent-based ink even in a case where ink droplets are scattered and attached to the adhesive, for example, when the ejection-side surface of the nozzle plate 28 is wiped. Therefore the ink jet head 10B can have improved reliability.

Further, the joined body 100 formed of the piezoelectric ceramic plate 21 and the ink chamber plate 25 is sandwiched between the spacers 110 and 110A, so that influences from any of the members constituting the ink jet head 10B other than the joined body 100 can be reduced in well balance.

Thus, deformation in piezoelectric ceramic plate 21 can be advantageously limited and an improvement in stability with which the solvent-based ink is ejected can be expected.

In this embodiment, since the spacer 110D is provided between the surfaces of the nozzle plate 28 and the nozzle support plate 31 to be joined to each other, it is not necessary to form the end surfaces of the spacers 110B and 110C and the end surface of the joined body 100, so as to be flush with each other by cutting the joined substrate in the same manner as in the above-described Embodiment 1. That is, if at least the end surfaces in the joined body 100′ formed of the piezoelectric ceramic plate 21 and the ink chamber plate 25 are flush with each other, the joined body 100 can be reliably joined to the nozzle plate 28 by virtue of the spacer 110D even if there is a gap between the end surfaces of the spacers 110B and 110C and the nozzle plate 28.

Therefore, a process may be used in which a joined substrate having a piezoelectric ceramic plate wafer and an ink chamber plate wafer joined to each other is formed and then cut to form joined bodies 100, and the spacers 110B and 110C are thereafter joined to each joined body 100 so as to sandwich the joined body 100. Needless to say, from the viewpoint of reliably preventing misalignment between the components forming the head chip at the time of joining, it is preferable to assemble the head chip by using the same method as that in the above-described Embodiment 1.

(Other Embodiments)

Embodiments 1 to 3 have been described above. The present invention, however, is not limited to the described arrangements.

For example, while PZT is mentioned as an example of the material of the piezoelectric ceramic plate 21 in the above descriptions of Embodiments 1 to 3, lead lanthanum zirconate titanate (PLZT) may alternatively be used and there is no particular restriction. Materials may be selected for the spacers 110, and 110A to 110D according to the linear expansion coefficient of the material of the piezoelectric ceramic plate 21 selected from various materials differing in linear expansion coefficient.

In the above-described Embodiments 1 to 3, the nozzle support plate 31 and the base plate 60 are formed from aluminum and the flow passage substrate 40 is formed from PPS. These materials, however, are not exclusively used. Materials having linear expansion coefficients close to that of the material of the piezoelectric ceramic plate 21, e.g., materials selected from PPS, a liquid crystal polymer (LCP), alumina, PZT, PLZT, etc., may be used to form the nozzle support plate 31, the base plate 60 and the flow passage substrate 40.

If the nozzle support plate 31 and the flow passage substrate 40 are formed from such materials having linear expansion coefficients close to that of the material of the piezoelectric ceramic plate 21, a direct joint may be formed between the joined body 100 and the nozzle support plate 31 and between the ink chamber plate 25 and the flow passage substrate 40 by high-hardness adhesive 27 insoluble in the solvent-based ink without providing a spacer. Alternatively, a spacer may be provided between each pair of mating joint surfaces to further improve the reliability of the ink jet head.

Further, while the ink chamber plate 25 is formed of a ceramic plate in the above-described Embodiments 1 to 3, it is not limited to a ceramic plate. For example, the ink chamber plate 25 may be formed from alumina having approximately the same linear expansion coefficient as that of the material of the piezoelectric ceramic plate 21.

In such a case, the ink chamber plate 25 functions as a spacer to limit deformation in piezoelectric ceramic plate 21, and the manufacturing cost can be markedly reduced.

Further, each of the spacers 110, and 110A to 110D is formed of as one integral member in the above-described Embodiments 2 and 3. However, the present invention is not limited to this. A spacer may be separately provided on the joint surface of each of the members to be joined to the piezoelectric ceramic plate 21 and the ink chamber plate 25. In such a case, the materials forming the spacers may be selected according to the differences between the linear expansion coefficients of the members constituting the ink jet head, i.e., the differences between the amounts of deformation by thermal expansion or shrinkage, to optimize the members in linear expansion coefficient, thereby further limiting deformation in the piezoelectric ceramic plate 21.

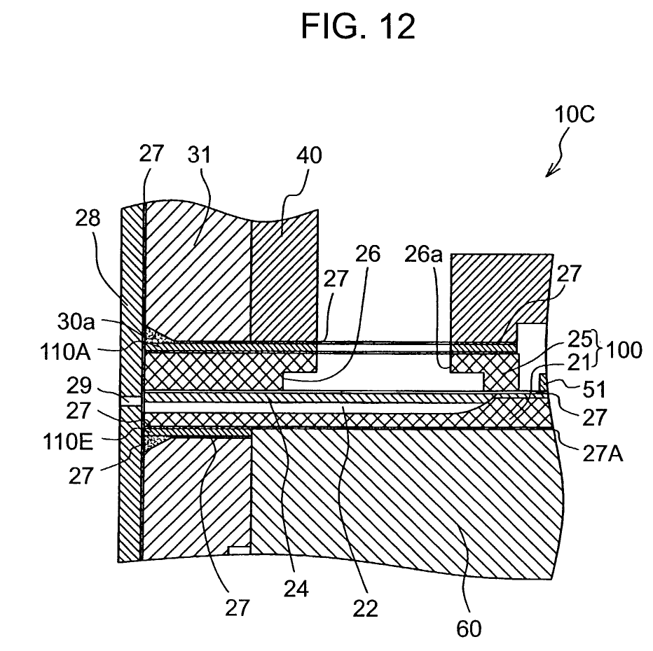

Also, the above-described Embodiments 1 to 3 have been described by way of example with respect to ink jet heads 10, 10A, and 10B in which a spacer is provided between the surface of the piezoelectric ceramic plate 21 and the surfaces of the nozzle support plate 31 and the base plate 60 to be joined to each other. However, the present invention is not limited to this. An ink jet head 10C such as shown in FIG. 12 may be formed in which a spacer 100E is provided only between the surfaces of the piezoelectric ceramic plate 21 and the nozzle support plate 31 to be joined to each other. FIG. 12 is an enlarged cross-sectional view of an essential portion of an ink jet head according to still another embodiment of the present invention.

In such a case, the joint surfaces of the piezoelectric ceramic plate 21 and the base plate 60 may be joined by a low-hardness adhesive 27A more elastic than the above-described high-hardness adhesive 27, so that this adhesive can absorb deformation in the base plate 60 to prevent deformation in piezoelectric ceramic plate 21. In this embodiment, an adhesive having a Shore hardness D of 60° is used as this low-hardness adhesive 27A.

Whatever the case may be, a satisfactory effect can be achieved if a spacer is provided in the manner explained in the description of Embodiment 1 between the surfaces of the piezoelectric ceramic plate 21 and the nozzle support plate 31 to be joined to each other. A suitable spacer may be provided between each pair of the other mating joint surfaces to further limit deformation in the piezoelectric ceramic plate 21. There is no particular restriction on the selection of the combination of joint surfaces between which a spacer is provided.

In the above description of Embodiment 3, a mention is made of a manufacturing method in which a joined substrate having a piezoelectric ceramic plate wafer and an ink chamber plate wafer joined to each other is formed and then cut to form joined bodies 100, and spacers 110B and 110C are thereafter joined to each joined body 100 on the opposite side of the joined body 100. However, such a manufacturing method may be applied to each of the above-described Embodiments 1 and 2.

The above-described ink jet head is mounted in an ink jet recording apparatus to perform printing on a recording medium.

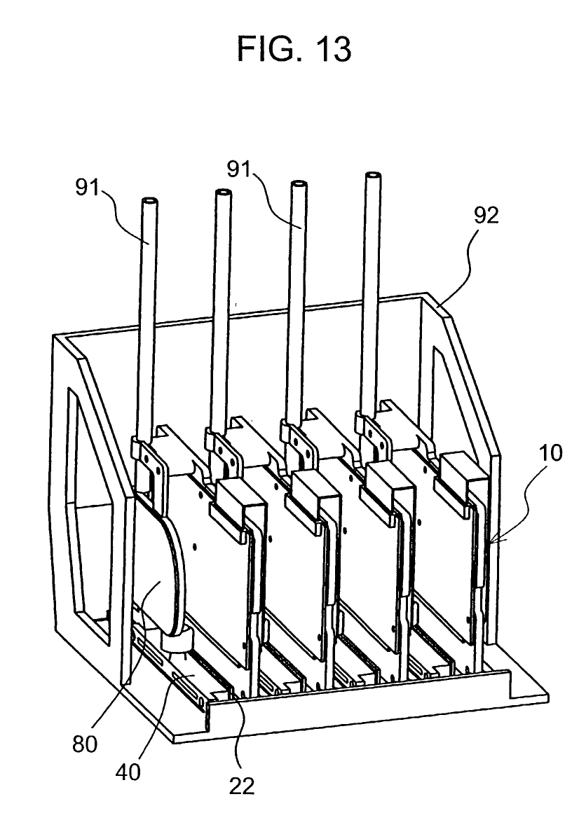

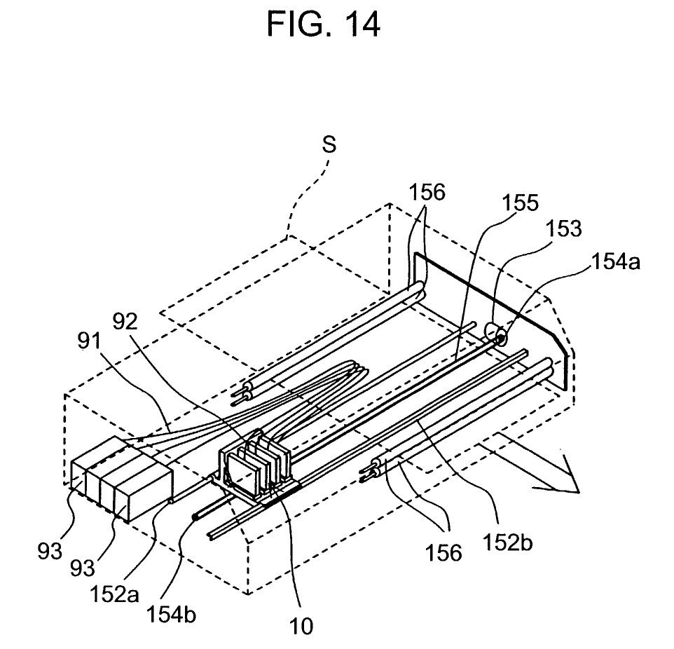

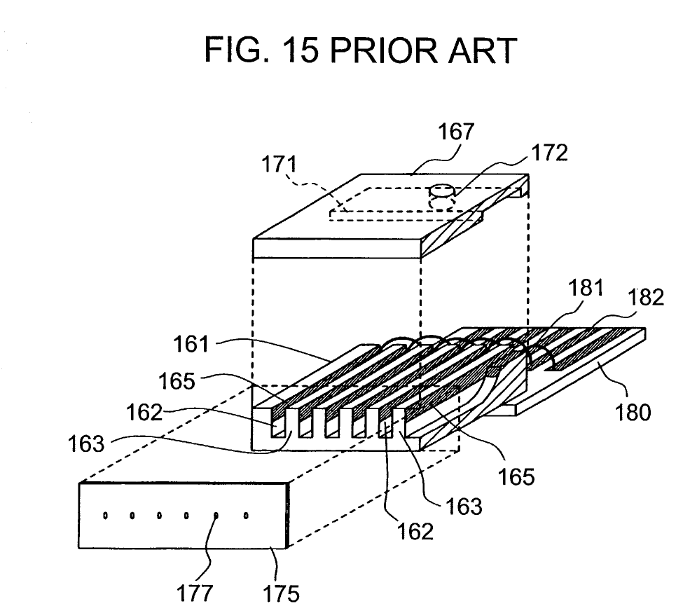

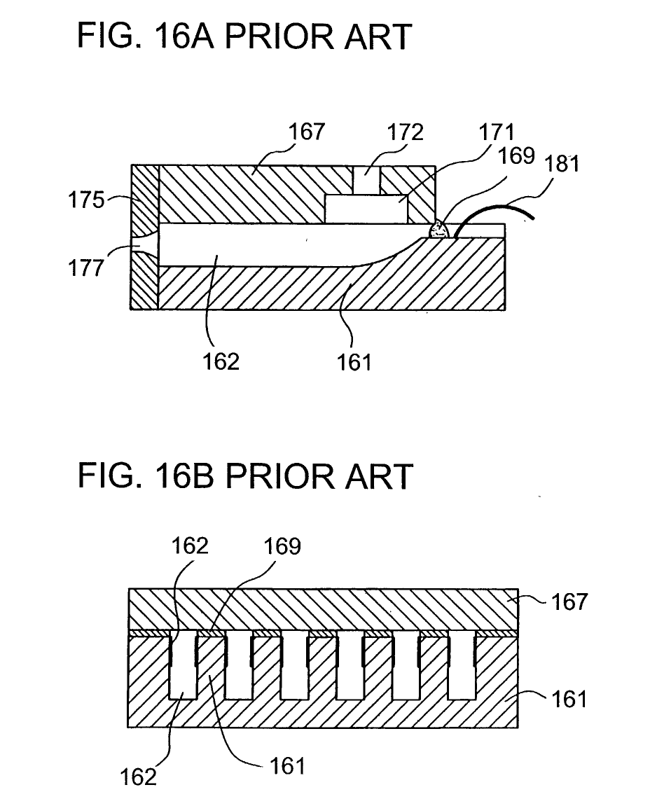

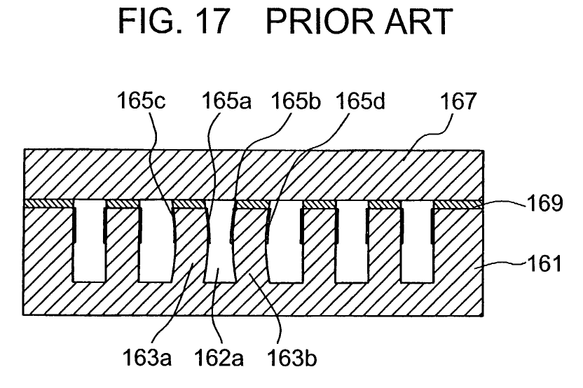

An ink jet recording apparatus will now be described. FIG. 13 is a perspective view of a carriage on which the ink jet head is mounted, and FIG. 14 is a schematic perspective view of the ink jet recording apparatus.

As illustrated in the drawing, the recording apparatus has a plurality of ink jet heads 10 provided in correspondence with colors, a carriage 92 on which the ink jet heads 10 are mounted in a state of being arranged along the main scanning direction, and ink cartridges 93 each supplying a solvent-based ink through an ink supply pipe 91 formed of a flexible tube. The carriage 92 is mounted on a pair of guide rails 152a and 152b so as to be movable in the axial direction. A drive motor 153 is provided at one end of the guide rails 152a and 152b. A drive force produced by the drive motor 153 is transmitted through a timing belt 155 wrapped around a pulley 154a connected to the drive motor 153 and a pulley 154b provided at the other end of the guide rails 152a and 152b.

Further, a pair of conveyance rollers 156 and 157 are provided along the guide rails 152a and 152b. These conveyance rollers 156 and 157 convey a recording medium S through a path below the carriage 92 in a direction perpendicular to the direction of conveyance by the carriage 92.

While recording medium S is being fed by the conveyance rollers 156 and 157, the carriage 92 is moved for scanning in the direction perpendicular to the feed direction. In this state, characters, images or the like are recorded on recording medium S by the ink jet heads 10.

When the carriage 92 moves during this recording, the pressure in the head chip 20 of each ink jet head 10 changes. However, the negative pressure regulating part 80 may be provided in the ink jet head 10 to perform pressure regulation with facility and to thereby enable suitable ejection of the solvent-based ink.

Each ink jet head 10 in this embodiment ejects ink in one color. In this embodiment, four ink jet heads 10 are mounted on the carriage 92 by being arranged in correspondence with four colors: black (B), yellow (Y), magenta (M), and cyan (C).

Also, four ink cartridges 93 are provided for the four colors in correspondence with the ink jet heads 10. These ink cartridges 93 are placed in a position lower than that of the nozzle openings of the ink jet heads 10 by a predetermined level so as to avoid obstructing the movement of the carriage 92 in the main scanning direction and the movement of recording medium S as well as to produce a negative pressure in the ink jet heads 10.

In this ink jet recording apparatus, recording medium S is moved along the sub-scanning direction while the ink jet heads 10 are moved along the main scanning direction, thereby enabling printing on the entire surface of recording medium S.

Although this embodiment has been described with respect to an example of the ink jet recording apparatus having a four-color ink jet head mounted thereon, the present invention is not limited to this. An ink jet recording apparatus may be arranged which has a five- to eight-color type of ink jet head mounted thereon.

According to the present invention, as described above, a spacer formed from a material having approximately the same linear expansion coefficient as that of the material of the piezoelectric ceramic plate is provided at least between the surfaces of the piezoelectric ceramic plate and the nozzle support plate to be joined to each other. The spacer can limit deformation in the piezoelectric ceramic plate due to the difference between the amounts of deformation by thermal expansion or shrinkage in the members constituting the ink jet head. Consequently, it is possible to reduce ink jet head product defects and to thereby improve the yield.

What is claimed is:

1. An ink jet head comprising:
a piezoelectric ceramic plate having a plurality of grooves to be filled with a solvent-based ink, and having electrodes on side walls of the grooves;
an ink chamber plate joined to the piezoelectric ceramic plate and having a common ink chamber communicating with each of the grooves;
a nozzle plate joined to an end surface of a joined body formed of the piezoelectric ceramic plate and the ink chamber plate in which the end surface has openings of the grooves, the nozzle plate having nozzle openings through each of which the solvent-based ink filling the corresponding groove is ejected; and
a nozzle support plate provided around a peripheral portion of the joined body on the nozzle plate side,
wherein a spacer formed from a material having approximately the same linear expansion coefficient as that of the material of the piezoelectric ceramic plate is provided at least between the surfaces of the piezoelectric ceramic plate and the nozzle support plate to be joined to each other.

2. An ink jet head according to claim 1, wherein the spacer is joined by an adhesive insoluble in the solvent-based ink.

3. An ink jet head according to claim 1, further comprising a base plate joined to the joined body on the piezoelectric ceramic plate side to hold the piezoelectric ceramic plate; and a flow passage substrate joined to the joined body on the ink chamber plate side to supply the solvent-based ink to the common ink chamber.

4. An ink jet head according to claim 3, wherein the spacer is provided between the surfaces of the piezoelectric ceramic plate in the joined body and said base plate to be joined to each other.

5. An ink jet head according to claims 1, wherein the spacer is provided between the surfaces of the ink chamber plate in the joined body and the nozzle support plate to be joined to each other.

6. An ink jet head according to claims 3, wherein the spacer is provided between the surfaces of the ink chamber plate in the joined body and the flow passage substrate to be joined to each other.

7. An ink jet head according to claims 1, wherein the spacer is provided between the surfaces of the nozzle plate and the nozzle support plate to be joined to each other.

8. An ink jet head according to claims 1, wherein the ink chamber plate is formed from a material having approximately the same linear expansion coefficient as that of the material of the piezoelectric ceramic plate.

9. An ink jet head according to claims 1, wherein the end surfaces of said joined body and the spacer to be joined to the nozzle plate are formed as a cut surface by cutting a joined substrate in which the joined body and the spacer are joined to each other, the end surfaces of the joined body and the spacer being flush with each other.

10. An ink jet head according to claims 1, wherein the base plate is formed from a material having approximately the same linear expansion coefficient as that of the material of the piezoelectric ceramic plate.

11. An ink jet head according to claims 1, wherein each of the nozzle support plate and the flow passage substrate is formed from a material having approximately the same linear expansion coefficient as that of the material of the piezoelectric ceramic plate.

12. An ink jet head comprising:
a piezoelectric ceramic plate having a plurality of grooves to be filled with a solvent-based ink, and having electrodes are formed on side walls of said grooves;
an ink chamber plate joined to the piezoelectric ceramic plate and having a common ink chamber communicating with each of the grooves;
a nozzle plate joined to an end surface of a joined body formed of the piezoelectric ceramic plate and the ink chamber plate in which the end surface has openings of the grooves, the nozzle plate having nozzle openings through each of which the solvent-based ink filling the corresponding groove is ejected; and
a nozzle support plate provided around a peripheral portion of the joined body on the nozzle plate side,
wherein each of the nozzle support plate and the ink chamber plate is formed from a material having approximately the same linear expansion coefficient as that of the material of the piezoelectric ceramic plate and is joined by an adhesive insoluble in the solvent-based ink.

13. An ink jet head according to claim 12, further comprising a base plate joined to the joined body on the ceramic plate side to hold the piezoelectric ceramic plate, wherein the base plate is formed from a material having approximately the same linear expansion coefficient as that of the material of the piezoelectric ceramic plate.

14. An ink jet head according to claim 12, further comprising a flow passage substrate joined to the joined body on the ink chamber plate side to supply the solvent-based ink to the common ink chamber, wherein the flow passage substrate being formed from a material having approximately the same linear expansion coefficient as that of the material of the piezoelectric ceramic plate.

15. A method of manufacturing an ink jet head having: a piezoelectric ceramic plate in which a plurality of grooves to be filled with a solvent-based ink are formed, and in which electrodes are formed on side walls of the grooves; an ink chamber plate joined to the piezoelectric ceramic plate and having a common ink chamber communicating with each of the grooves; a nozzle plate joined to an end surface of a joined body formed of the piezoelectric ceramic plate and the ink chamber plate in which the end surface has openings of the grooves, the nozzle plate having nozzle openings through each of which the solvent-based ink filling the corresponding groove is ejected; and a nozzle support plate provided around a peripheral portion of the joined body on the nozzle plate side,
the method comprising the step of:
forming a joined substrate by joining together a piezoelectric ceramic plate wafer in which a plurality of the grooves are formed and an ink chamber plate wafer in which a plurality of the common ink chambers are formed, and by joining a spacer wafer to the piezoelectric ceramic plate wafer on the side opposite from the side on which the ink chamber plate wafer is joined and at least in a region where the nozzle support plate is joined, the spacer serving as a spacer and being formed from a material having approximately the same linear expansion coefficient as that of the material of the piezoelectric ceramic plate being formed from the spacer wafer;
cutting the joined substrate to form the end surface to be joined to the nozzle plate; and
joining the nozzle plate to the joint end surface and joining the nozzle support plate to the joined body with the spacer interposed between the nozzle support plate and the joined body.

16. A method of manufacturing an ink jet head according to claim 15, wherein the spacer is joined by an adhesive insoluble in the solvent-based ink.

17. A method of manufacturing an ink jet head according to claim 15, further comprising a step of joining to the joined body on the piezoelectric ceramic plate side a base plate for holding the piezoelectric ceramic plate; and a step of joining to the joined body on the ink chamber plate side a flow passage substrate for supplying the solvent-based ink to the common ink chamber.

18. A method of manufacturing an ink jet head according to claim 17, wherein the step of forming the joined substrate comprises joining the spacer wafer also between the surfaces of the piezoelectric ceramic plate in the piezoelectric ceramic plate wafer and the base plate to be joined to each other, and the step of joining the base plate comprises joining the piezoelectric ceramic plate and the base plate with the spacer interposed therebetween.

19. A method of manufacturing an ink jet head according to claims 17, wherein the step of forming the joined substrate comprises joining the spacer wafer also between the surfaces of the ink chamber plate in the ink chamber plate wafer and the nozzle support plate to be joined to each other, and the step of joining the nozzle support plate comprises joining the ink chamber plate and the nozzle support plate with the spacer interposed therebetween.

20. A method of manufacturing an ink jet head according to claims 17, wherein the step of forming the joined substrate comprises joining the spacer wafer also between the surfaces of the ink chamber plate in the ink chamber plate wafer and the flow passage substrate to be joined to each other, and the step of joining the nozzle support plate comprises joining the ink chamber plate and the flow passage substrate with the spacer interposed therebetween.

21. A method of manufacturing an ink jet head according to claims 15, wherein the nozzle plate and the nozzle support are joined to each other with the spacer interposed therebetween.

22. A method of manufacturing an ink jet head according to claims 17, wherein the material forming the base plate has approximately the same linear expansion coefficient as that of the material of the piezoelectric ceramic plate.

23. A method of manufacturing an ink jet head according to claims 17, wherein each of the material forming the nozzle support plate and the flow passage substrate has approximately the same linear expansion coefficient as that of the material of the piezoelectric ceramic plate.

24. A method of manufacturing an ink jet head according to claims 15, wherein the material forming the ink chamber plate has approximately the same linear expansion coefficient as that of the material of the piezoelectric ceramic plate.

25. An ink jet recording apparatus having an ink jet head according to claim 1, wherein the ink jet head is mounted on a carriage, the carriage is moved for scanning in the direction perpendicular to the feed direction, and in this state, characters, images or the like are recorded on recording medium by the ink jet head.
